(19) United States
(12) Patent Application Publication
(10) Pub. No.: US 2026/0059043 A1
(43) Pub. Date: Feb. 26, 2026

(54) FOLDABLE ELECTRONIC DEVICE AND METHOD FOR OPERATING SAME

(71) Applicant: Samsung Electronics Co., Ltd., Suwon-si (KR)

(72) Inventors: Heewoong KIM, Suwon-si (KR); Sanggeon KIM, Suwon-si (KR); Sooryuh KIM, Suwon-si (KR); Jeongmin PARK, Suwon-si (KR); Miyeoung CHUNG, Suwon-si (KR)

(21) Appl. No.: 19/377,802

(22) Filed: Nov. 3, 2025

Related U.S. Application Data
(63) Continuation of application No. PCT/KR2024/007313, filed on May 29, 2024.

(30) Foreign Application Priority Data
Jun. 2, 2023 (KR) 10-2023-0071304
Jun. 9, 2023 (KR) 10-2023-0074371

(51) Int. Cl. H04M 1/72454; H04M 1/02

(52) U.S. Cl. CPC H04M 1/72454; H04M 1/0216; H04M 2201/38; H04M 2250/12

(57) ABSTRACT

A foldable electronic device is provided. The foldable electronic device includes a first housing, a second housing rotatably coupled to the first housing, a main display including a first display region provided on the first housing and a second display region provided on the second housing, a sub-display including a third display region of the first housing, the third display region being configured to display a screen in a different direction from the first display region, at least one sensor configured to acquire at least one measurement value related to rotation of the foldable electronic device, memory, comprising one or more storage media, storing instructions, and at least one processor including processing circuitry, the at least one processor communicatively coupled to the memory, wherein the instructions, when executed by the at least one processor individually or collectively, cause the foldable electronic device to display an execution screen of a first application on the main display, based on execution of the first application, detect rotation of the foldable electronic device, based on the at least one measurement value acquired from the at least one sensor, wake up the sub-display, based on the detection of the rotation of the foldable electronic device, and display a screen related to the execution screen of the first application on the sub-display.

### CROSS-REFERENCE TO RELATED APPLICATION(S)

This application is a continuation application, claiming priority under 35 U.S.C. § 365(c), of an International application No. PCT/KR2024/007313, filed on May 29, 2024, which is based on and claims the benefit of a Korean patent application number 10-2023-0071304, filed on Jun. 2, 2023, in the Korean Intellectual Property Office, and of a Korean patent application number 10-2023-0074371, filed on Jun. 9, 2023, the disclosure of each of which is incorporated by reference herein in its entirety.

### BACKGROUND

### 1. Field

The disclosure relates to a foldable electronic device and a method for operating the same.

### 2. Description of Related Art

Electronic devices may perform complex functions by incorporating various functions. For example, electronic devices may perform mobile communication functions, data communication functions, data output functions, data storage functions, video recording functions, voice recording functions, and the like. Such electronic devices may have a display unit and an input unit. In this case, the display unit and the input unit may be combined to be implemented as a touch screen. In addition, the electronic device may execute and control functions through the touch screen.

As the demand for mobile communication increases and the integration of electronic devices increases, various technologies are being developed to improve the portability of electronic devices such as mobile communication terminals and to enhance user convenience in using multimedia functions. Recently, various types of electronic devices are being developed to provide a more expanded screen in electronic devices by a multi-display. For example, a plurality of displays are provided to provide an expanded screen by a multi-display.

Electronic devices may have a new form factor, such as a multi-display (e.g., dual display) device (e.g., foldable device). A foldable device may have a foldable (or bendable) display (e.g., foldable display or flexible display) and may be used in a folded or unfolded state. In addition, with the implementation of the multi-display, the need for development of a user interface (UI) corresponding to the multi-display and its operation is increasing.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a foldable electronic device and a method for operating the same.

Additional aspects will be set forth in part in the description which follows and, in part, will be apparent from the description, or may be learned by practice of the presented embodiments.

In accordance with an aspect of the disclosure, a foldable electronic device is provided. The foldable electronic device includes a first housing, a second housing rotatably coupled to the first housing, a main display including a first display region provided on the first housing and a second display region provided on the second housing, a sub-display including a third display region of the first housing, the third display region being configured to display a screen in a different direction from the first display region, at least one sensor configured to acquire at least one measurement value related to rotation of the foldable electronic device, memory, including one or more storage media, storing instructions, and at least one processor including processing circuitry, the at least one processor communicatively coupled to the memory, wherein the instructions, when executed by the at least one processor individually or collectively, cause the foldable electronic device to display an execution screen of a first application on the main display, based on execution of the first application, detect rotation of the foldable electronic device, based on the at least one measurement value acquired from the at least one sensor, wake up the sub-display, based on the detection of the rotation of the foldable electronic device, and display a screen related to the execution screen of the first application on the sub-display.

In accordance with another aspect of the disclosure, an operation method of a foldable electronic device is provided. The operation method includes displaying an execution screen of a first application on a main display, based on execution of the first application, the main display includes a first display region of a first housing and a second display region of a second housing rotatably coupled to the first housing, detecting rotation of the foldable electronic device, based on at least one measurement value acquired from at least one sensor and related to the rotation of the foldable electronic device, waking up a sub-display, based on the detection of the rotation of the foldable electronic device, the sub-display includes a third display region of the first housing configured to display a screen in a different direction from the first display region, and displaying a screen related to the execution screen of the first application on the sub-display.

In accordance with another aspect of the disclosure, a foldable electronic device is provided. The foldable electronic device includes a first housing, a second housing rotatably coupled to the first housing, a main display comprising a first display region provided on the first housing and a second display region provided on the second housing, a sub-display comprising a third display region of the first housing, the third display region being configured to display a screen in a different direction from the first display region, memory, comprising one or more storage media, storing instructions; and at least one processor including processing circuitry, the at least one processor communicatively coupled to the memory, wherein the instructions, when executed by the at least one processor individually or collectively, cause the foldable electronic device to display an execution screen of a first application on the main display, based on execution of the first application, execute a second application, based on a request of the first application, display, based on the second application, a screen related to the execution screen of the first application, which reflects at least a portion of the execution screen of the first application, on the sub-display, and provide an input corresponding to at least one of the execution screen of the first application or a screen related to the execution screen of the first application to the first application and the second application, respectively.

In accordance with another aspect of the disclosure, a computer-readable storage medium storing instructions, wherein the instructions cause, when executed by at least one processor of a foldable electronic device, the foldable electronic device to display an execution screen of a first application on a main display, based on execution of the first application is provided. The main display includes a first display region of a first housing and a second display region of a second housing rotatably coupled to the first housing. The instructions cause, when executed by the at least one processor, the foldable electronic device to detect rotation of the foldable electronic device, based on at least one measurement value acquired from at least one sensor and related to the rotation of the foldable electronic device. The instructions cause, when executed by the at least one processor, the foldable electronic device to wake up a sub-display, based on the detection of the rotation of the foldable electronic device. The sub-display includes a third display region of the first housing configured to display a screen in a different direction from the first display region. The instructions cause, when executed by the at least one processor, the foldable electronic device to display a screen related to the execution screen of the first application on the sub-display. A foldable electronic device according to an embodiment of the disclosure includes a first housing, a second housing rotatably coupled to the first housing, a main display including a first display region of the first housing and a second display region of the second housing, a sub-display including a third display region of the first housing, the third display region being configured to display a screen in a different direction from the first display region, memory configured to store instructions, and at least one processor. The instructions cause, when executed by the at least one processor, the foldable electronic device to display an execution screen of a first application on the main display, based on execution of the first application. The instructions cause, when executed by the at least one processor, the foldable electronic device to execute a second application, based on a request of the first application. The instructions cause, when executed by the at least one processor, the foldable electronic device to display, based on the second application, a screen related to the execution screen of the first application, which reflects at least a portion of the execution screen of the first application, on the sub-display. The instructions cause, when executed by the at least one processor, the foldable electronic device to provide an input corresponding to at least one of the execution screen of the first application or a screen related to the execution screen of the first application to the first application and the second application, respectively.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram of an electronic device in a network environment according to an embodiment of the disclosure;

FIG. 2 is a block diagram of an electronic device according to an embodiment of the disclosure;

FIG. 3A illustrates an operation of identifying a screen display direction, based on an inertial sensor, according to an embodiment of the disclosure;

FIG. 3B illustrates an operation of identifying a screen display direction, based on an illuminance sensor, according to an embodiment of the disclosure;

FIG. 3C illustrates an operation of identifying a screen display direction, based on a camera sensor, according to an embodiment of the disclosure;

FIGS. 4A, 4B, and 4C illustrate various folding states of an electronic device according to various embodiments of the disclosure;

FIGS. 5A, 5B, and 5C illustrate various mounting states of an electronic device according to various embodiments of the disclosure;

FIGS. 6A and 6B illustrate a main display and a sub-display displaying first content and second content, respectively, according to various embodiments of the disclosure;

FIGS. 7A, 7B, 7C, 7D, 7E, and 7F illustrate examples of first content and second content of an electronic device according to various embodiments of the disclosure;

FIG. 8 illustrates changes in first content and second content of an electronic device according to an embodiment of the disclosure;

FIG. 9 illustrates a first display and a second display of an electronic device according to an embodiment of the disclosure;

FIG. 10A illustrates a state in which an electronic device operates in a concurrency mode according to an embodiment of the disclosure;

FIG. 10B illustrates signal transmission of an electronic device in a concurrency mode according to an embodiment of the disclosure;

FIGS. 11A and 11B illustrate a first example of an electronic device operating in a concurrency mode according to various embodiments of the disclosure;

FIGS. 12A and 12B illustrate a second example of an electronic device operating in a concurrency mode according to various embodiments of the disclosure;

FIG. 13 is a flowchart of a method of operating an electronic device according to an embodiment of the disclosure; and

FIG. 14 is a flowchart of a method of operating an electronic device according to an embodiment of the disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

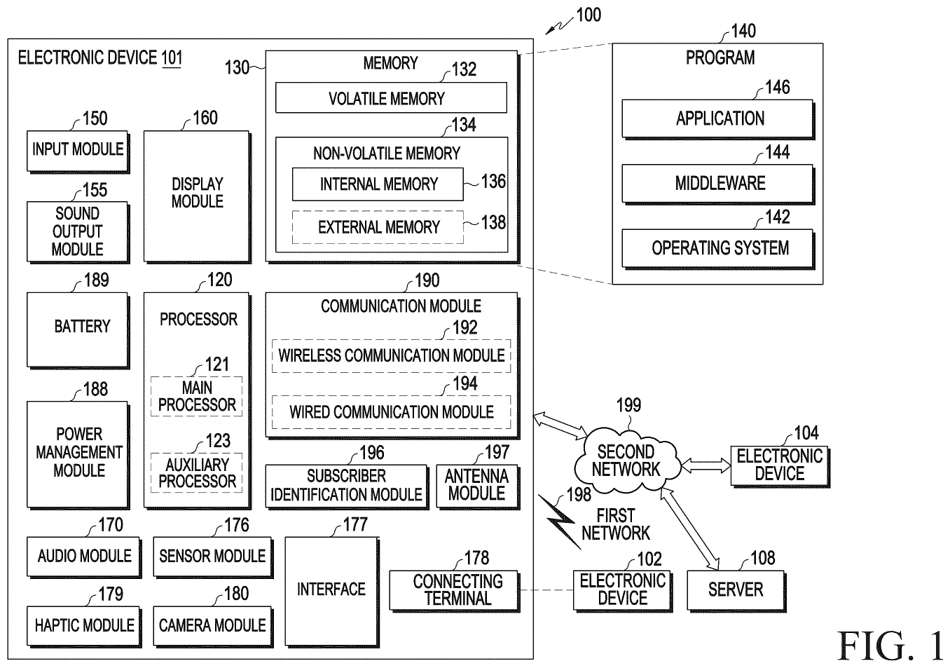

FIG. 1 is a block diagram illustrating an electronic device 101 in a network environment 100 according to an embodiment of the disclosure.

Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™ wireless-fidelity (Wi-Fi) direct, or infrared data association (IrDA)) or the second network 199 (e.g., a long-range communication network, such as a legacy cellular network, a fifth-generation (5G) network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a fourth-generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the millimeter wave (mmWave) band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to an embodiment, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or server 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

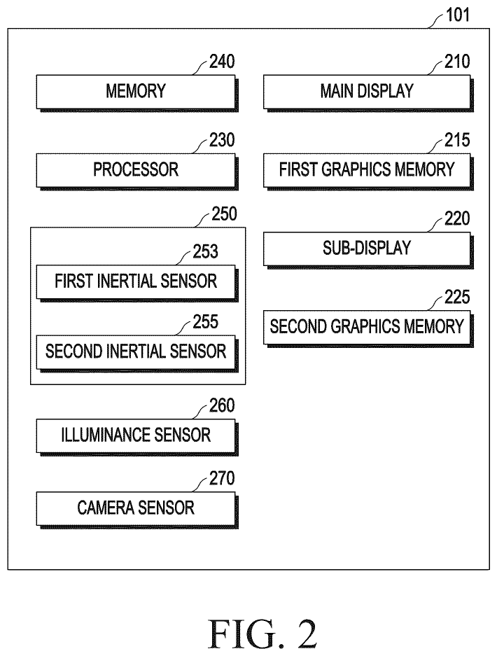

FIG. 2 is a block diagram of an electronic device 101 according to an embodiment of the disclosure.

Referring to FIG. 2, an electronic device 101 according to an embodiment may include a main display 210, a sub-display 220, first graphics memory 215, second graphics memory 225, a processor 230, (e.g., the processor 120 in FIG. 1), memory 240 (e.g., the memory 130 in FIG. 1), an inertial sensor 250, an illuminance sensor 260, and/or a camera sensor 270.

The electronic device 101 according to an embodiment may include a main display 210 on the front side and a sub-display 220 on the back side. As an embodiment, the display exposed to the user may switch between the main display 210 and the sub-display 220 by rotation (e.g., flip) of the electronic device 101.

In the electronic device 101 according to an embodiment, the main display 210 and/or the sub-display 220 may be rotated by folding at least a portion, thereby changing a screen display direction. As an embodiment, the main display 210 may be a flexible display that is folded by folding the electronic device 101, and the sub-display 220 may be provided on the back side of a partial area of the main display 210.

The main display 210 according to an embodiment may display a screen including visual information on one side of the electronic device 101. As an embodiment, the electronic device 101 may have a shape that extends in a plane direction, and a main display 210 may be disposed in one direction of the extended plane.

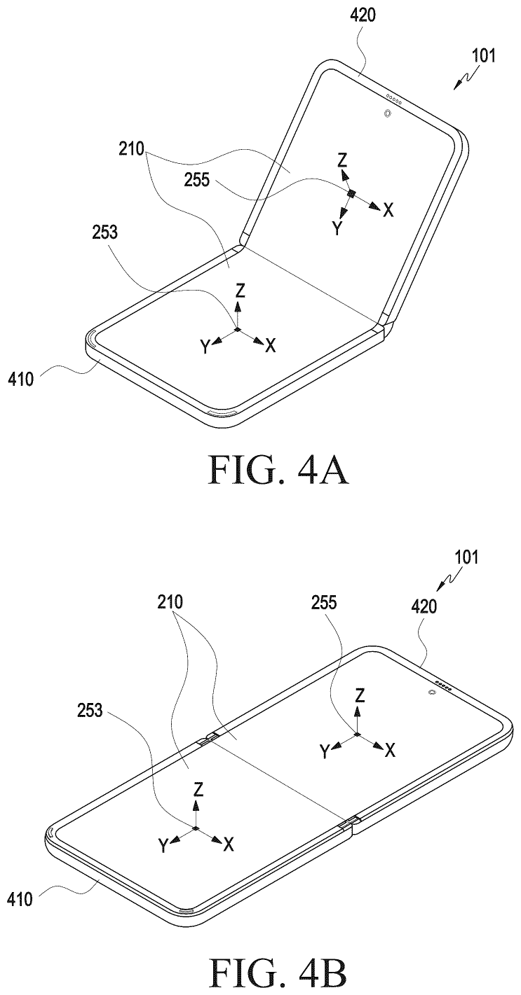

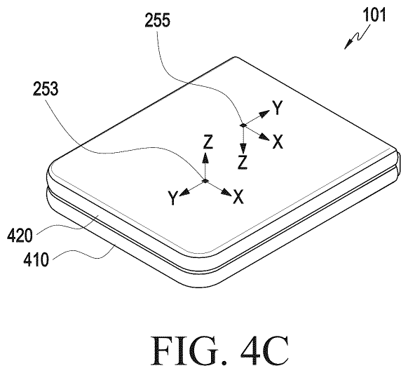

As an embodiment, the main display 210 may be a foldable flexible display, and may be folded by rotation between a plurality of housings (e.g., the first housing 410 and the second housing 420 in FIG. 4A) that are rotatably coupled to each other. As an embodiment, the flexible main display 210 may be rollable, foldable, or bendable.

As an embodiment, the main display 210 may be divided into a plurality of display regions, and may be folded at the boundaries between the plurality of display regions. As an embodiment, the electronic device 101 may be a foldable device that is configured with a plurality of housings 410 and 420 corresponding to the first display region and the second display region of the main display 210, and is folded in a direction in which the first display region and the second display region of the main display 210 approach to each other by the rotation of the plurality of housings 410 and 420. The first display region is provided on the first housing 410 and the second display region is provided on the second housing 420.

The sub-display 220 according to an embodiment may display a screen including visual information on the other side of the electronic device 101. As an embodiment, the electronic device 101 may have a shape that extends in a planar direction, and the sub-display 220 may be disposed on the back side of the main display 210 or a partial area of the main display 210 so as to display a screen in a direction opposite the main display 210 or the partial area of the main display 210.

For example, the sub-display 220 may be formed relatively smaller than the main display 210. For example, in the case where the electronic device 101 is a foldable device, the sub-display 220 may correspond to some of the plurality of housings 410 and 420 so as to correspond to the first display region or the second display region of the main display 210.

The first graphics memory 215 according to an embodiment may store image data to be displayed on the main display 210. As an embodiment, the electronic device 101 may transmit the image data stored in the first graphics memory 215 to the main display 210, thereby displaying a screen on the main display 210. For example, the first graphics memory 215 may be graphics random-access memory (GRAM).

The second graphics memory 225 according to an embodiment may store image data to be displayed on the sub-display 220. As an embodiment, the electronic device 101 may transmit image data stored in the second graphics memory 225 to the sub-display 220, thereby displaying a screen on the sub-display 220. For example, the second graphics memory 225 may be graphics random-access memory (GRAM).

As an embodiment, the first graphics memory 215 that stores image data to be displayed on the main display 210 and the second graphics memory 225 that stores image data to be displayed on the sub-display 220 may be provided separately from each other.

The processor 230 according to an embodiment may control at least one other component (e.g., hardware or software component) of the electronic device 101. As an embodiment, the processor 230 may perform various data processing or operations, store, as at least a part of the data processing or operations, commands or data received from other components in the memory 240, process the commands or data stored in the memory 240, and store result data in the memory 240.

The memory 240 according to an embodiment may store instructions executable by the processor.

The electronic device 101 according to an embodiment may determine whether specified conditions related to the screen display direction of the main display 210 or the sub-display 220 are satisfied based on at least one value acquired through at least one sensor 250, 260, or 270.

As an embodiment, at least one sensor 250, 260, or 270 may include an inertial sensor 250, an illuminance sensor 260, and/or a camera sensor 270.

The inertial sensor 250 according to an embodiment may be an accelerometer or a gyro sensor that detects acceleration or angular velocity of an electronic device 101. As an embodiment, the inertial sensor 250 may measure acceleration and angular velocity in six-axis directions.

The illuminance sensor 260 according to an embodiment may measure the density of light flux generated from a light source.

The camera sensor 270 according to an embodiment may detect an object located within a field of view (FOV). As an embodiment, the camera sensor 270 may detect whether a user is located within a field of view. For example, the camera sensor 270 may recognize a user's face. For example, the camera sensor 270 may recognize a user's iris.

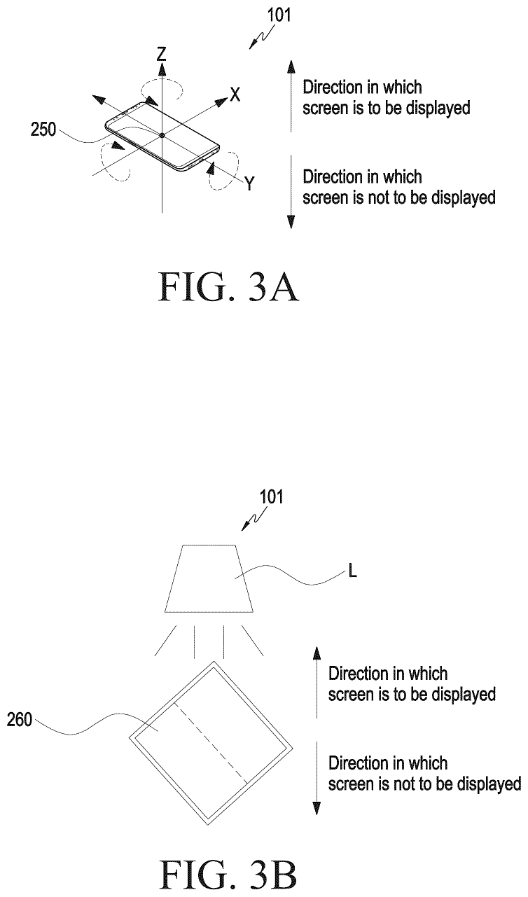

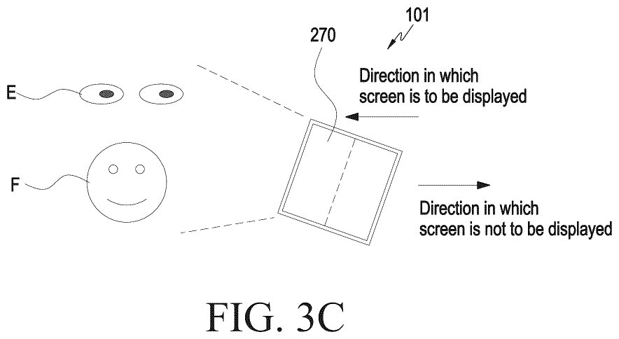

FIG. 3A illustrates an operation of identifying a screen display direction, based on an inertial sensor 250, according to an embodiment of the disclosure.

FIG. 3B illustrates an operation of identifying a screen display direction, based on an illuminance sensor 260, according to an embodiment of the disclosure.

FIG. 3C illustrates an operation of identifying a screen display direction, based on a camera sensor 270, according to an embodiment of the disclosure.

Referring to FIGS. 3A, 3B, and 3C, the electronic device 101 according to an embodiment may identify a screen display direction, based on at least one value acquired from at least one sensor 250, 260, or 270. As an embodiment, the electronic device 101 may determine whether specified conditions are satisfied based on whether the identified screen display direction of the electronic device 101 corresponds to a screen display direction of the sub-display.

Referring to FIG. 3A, the electronic device 101 according to an embodiment may identify a gravity direction (−Z axis), based on a measurement value of the inertial sensor 250. As an embodiment, the electronic device 101 may identify a direction corresponding to the gravity direction (−Z axis) as a direction in which the screen is not to be displayed based on the identified gravity direction (−Z axis). As an embodiment, the electronic device 101 may identify the direction opposite the gravity direction (−Z axis) as a direction in which the screen is to be displayed based on the identified gravity direction (−Z axis).

Referring to FIG. 3B, the electronic device 101 according to an embodiment may identify the direction in which the light source L is located based on a measurement value of the illuminance sensor 260. As an embodiment, the electronic device 101 may identify the direction in which the light source L is located as a direction in which the screen is to be displayed based on the identified direction in which the light source L is located. As an embodiment, the electronic device 101 may identify the direction in which the light source L is not located as a direction in which the screen is not to be displayed based on the identified direction in which the light source L is located.

Referring to FIG. 3C, the electronic device 101 according to an embodiment may identify the user's location, based on a measurement value of the camera sensor 270. As an embodiment, the electronic device 101 may recognize the user's face F or eyeball E and identify the position of the recognized face F or eyeball E. As an embodiment, the electronic device 101 may identify the direction in which the user is located as a direction in which the screen is to be displayed based on the identified user's location. As an embodiment, the electronic device 101 may identify the direction in which the user is not located as a direction in which the screen is not to be displayed based on the identified user's location.

According to an embodiment, the electronic device 101 may determine whether the identified direction in which the screen of the identified electronic device 101 is to be displayed corresponds to the screen display direction of the sub-display 220. For example, the electronic device 101 may determine that a specified condition is satisfied in the case where the direction in which the screen of the electronic device 101 is to be displayed and the screen display direction of the sub-display 220 are adjacent directions. For example, in the case where the direction in which the screen of the electronic device 101 is to be displayed is opposite the direction in which the screen display direction of the sub-display 220 (e.g., in the case where it is a direction adjacent to the direction in which the screen of the main display 210 is displayed), the electronic device 101 may determine that a specified condition is not satisfied.

FIGS. 4A, 4B, and 4C illustrate various folding states of an electronic device according to various embodiments of the disclosure.

Referring to FIGS. 4A, 4B, and 4C, the electronic device 101 according to an embodiment may include a first housing 410 and a second housing 420 that are rotatably coupled to each other. As an embodiment, the electronic device 101 may identify the direction in which the screen of the electronic device 101 is to be displayed or the direction in which the screen is not to be displayed based on the folding state of the electronic device 101.

The electronic device 101 according to an embodiment may be a foldable device in which a plurality of housings 410 and 420 are rotatably coupled to each other. As an embodiment, a main display (e.g., the main display 210 in FIG. 2) of the electronic device 101 may be a flexible display that is foldable, and may be positioned on a plane where the plurality of housings 410 and 420 are folded.

As an embodiment, a sub-display (e.g., the sub-display 220 in FIG. 2) may be positioned on the opposite side of the plane where the plurality of housings 410 and 420 are folded, and may be positioned on the back side of a partial area of the main display 210.

Referring to FIG. 4B, the electronic device 101 may be in an unfolded state in which the first housing 410 and the second housing 420 are positioned side by side in the lateral direction so that the main display 210 is unfolded in a planar direction.

Referring to FIG. 4C, the electronic device 101 may be in a folded state in which the first housing 410 and the second housing 420 are positioned in a vertical direction so that at least portions of the main display 210 come into contact with each other. As an embodiment, in the folded state of the electronic device 101, the main display 210 may be folded to be in contact with each other, so that it may not be exposed to the outside.

Referring to FIG. 4A, the electronic device 101 may be in a partially folded state in which it is rotated and/or fixed at various angles between the unfolded state and the folded state.

As an embodiment, the electronic device 101 may include a first inertial sensor 253 that acquires at least one first value related to the rotation of the first housing 410. As an embodiment, the electronic device 101 may include a second inertial sensor 255 that acquires at least one second value related to the rotation of the second housing 420.

As an embodiment, the electronic device 101 may identify a folding state of the electronic device 101, based on at least one first value acquired from the first inertial sensor 253 and at least one second value acquired from the second inertial sensor 255. As an embodiment, the electronic device 101 may identify the gravity direction or coordinate system of the first housing 410, based on at least one first value acquired from the first inertial sensor 253. As an embodiment, the electronic device 101 may identify the gravity direction or coordinate system of the second housing 420, based on at least one second value acquired from the second inertial sensor 255. As an embodiment, the folding state of the electronic device 101 may be identified using the gravity direction or coordinate system of the first housing 410 and the gravity direction or coordinate system of the second housing 420.

For example, the electronic device 101 may be identified as being in the unfolded state as illustrated in FIG. 4B in the case where the gravity direction or coordinate system of the first housing 410 and the gravity direction or coordinate system of the second housing 420 match each other. For example, the electronic device 101 may be identified as being in the folded state as illustrated in FIG. 4C in the case where the gravity direction or coordinate system of the first housing 410 and the gravity direction or coordinate system of the second housing 420 are opposite to each other.

The electronic device 101 according to an embodiment may determine whether a specified condition is satisfied based on the identified folding state of the electronic device 101. For example, the electronic device 101 may determine that the specified condition is satisfied in the folded state in which the main display 210 is not exposed. For example, the electronic device 101 may determine that the specified condition is not satisfied in the unfolded state in which the main display 210 is exposed. For example, the electronic device 101 may determine that the specified condition is satisfied in the partial folded state in which the main display 210 and the sub-display 220 are simultaneously exposed.

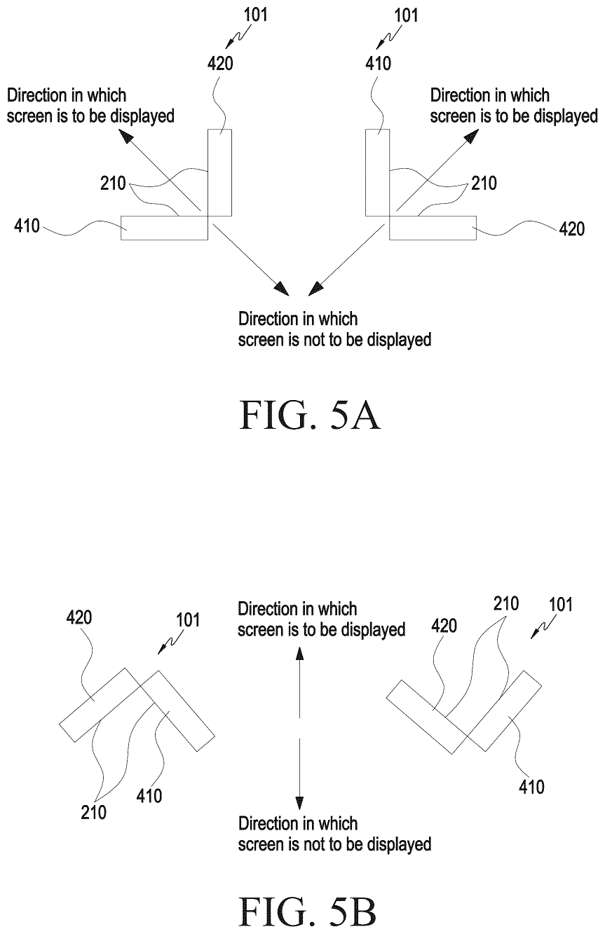

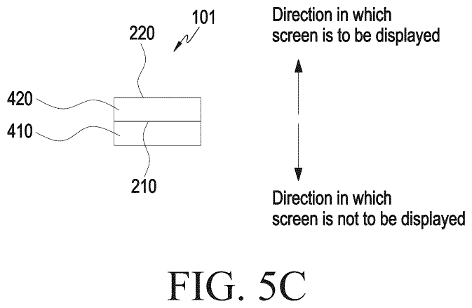

FIGS. 5A, 5B, and 5C illustrate various mounting states of an electronic device 101 according to various embodiments of the disclosure.

Referring to FIGS. 5A, 5B, and 5C, the electronic device 101 according to an embodiment may be mounted in various mounting states in various folding states. The electronic device 101 according to an embodiment may identify the direction in which a screen is to be displayed or the direction in which a screen is not to be displayed based on the mounting state of the electronic device 101.

When the electronic device 101 according to an embodiment is in the partially folded state fixed at an angle between the folded state and the unfolded state, as illustrated in FIGS. 5A and 5B, a main display (e.g., the main display 210 in FIG. 2) and a sub-display (e.g., the sub-display 220 in FIG. 2) may be simultaneously exposed to the outside. As an embodiment, the electronic device 101 may be mounted in various attitudes in the partially folded state.

As an embodiment, the electronic device 101 may be mounted in a flex mode in which the first housing 410 or the second housing 420 is disposed parallel to the floor or ground, as illustrated in FIG. 5A. As an embodiment, the electronic device 101 may identify the direction in which the main display 210 is exposed (e.g., the screen display direction) as the direction in which the screen is to be displayed in the flex mode. As an embodiment, the electronic device may identify the back side of the main display 210 as the direction in which the screen is not to be displayed in the flex mode.

As an embodiment, the electronic device 101 may be mounted in a tent mode in which the first housing 410 and the second housing 420 are disposed at an angle with the floor or ground, as illustrated in FIG. 5B. As an embodiment, the electronic device 101 may identify the upward direction according to the gravity direction as the direction in which the screen is to be displayed in the tent mode. As an embodiment, the electronic device 101 may identify the downward direction according to the gravity direction as the direction in which the screen is not to be displayed in the tent mode.

As an embodiment, the electronic device 101 may be mounted in a folded state, as illustrated in FIG. 5C. As an embodiment, in the folded state of the electronic device 101, the main display 210 may not be exposed to the outside. As an embodiment, the electronic device 101 may identify the upward direction according to the gravity direction as the direction in which the screen is to be displayed in the folded state. As an embodiment, the electronic device 101 may identify the downward direction according to the gravity direction as the direction in which the screen is not to be displayed in the folded state.

As an embodiment, the electronic device 101 may identify the direction in which the sub-display 220 is exposed (e.g., the screen display direction) as the direction in which the screen is to be displayed in the folded state. As an embodiment, the electronic device 101 may identify the backside direction of the sub-display 220 as the direction in which the screen is not to be displayed in the folded state.

As an embodiment, the electronic device 101 may determine whether the identified direction in which the screen of the electronic device 101 is to be displayed corresponds to the screen display direction of the sub-display 220. For example, the electronic device 101 may determine that a specified condition is satisfied in the case where the direction in which the screen of the electronic device 101 is to be displayed and the screen display direction of the sub-display 220 are adjacent directions. For example, the electronic device 101 may determine that the specified condition is not satisfied in the case where the direction in which the screen of the electronic device 101 is to be displayed and the screen display direction of the sub-display 220 are opposite directions (e.g., in the case where it is a direction adjacent to the screen display direction of the main display 210).

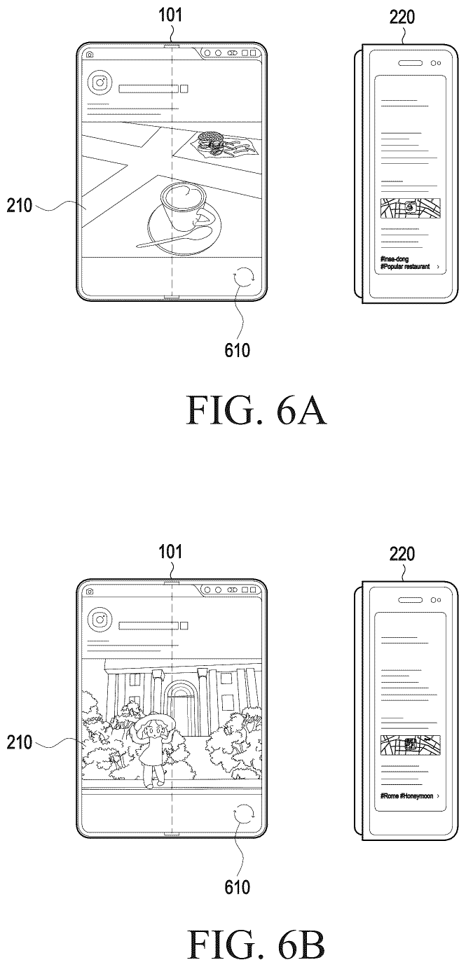

FIGS. 6A and 6B illustrate a main display 210 and a sub-display 220 displaying first content and second content, respectively, according to various embodiments of the disclosure.

Referring to FIGS. 6A and 6B, an electronic device 101 (e.g., the processor 120 in FIG. 1 or the processor 230 in FIG. 2) according to an embodiment may identify first content to be displayed on a screen, based on an executed first application. As an embodiment, the first content may be an execution screen of the first application. As an embodiment, the electronic device 101 according to an embodiment may display the identified first content on the main display 210.

As an embodiment, the electronic device 101 according to an embodiment may identify second content, based on the first application. The electronic device 101 according to an embodiment may identify the second content, based on a second application executed reflecting an input to the first content. As an embodiment, the second content may be a screen related to the execution screen of the first application (e.g., the first content).

The electronic device 101 according to an embodiment may display the identified second content on the sub-display 220, based on the satisfaction of a specified condition.

The electronic device 101 according to an embodiment may execute a first application, based on a user's input (e.g., a touch input). The electronic device 101 according to an embodiment may execute a first task in the first application, based on a user's input. The electronic device 101 according to an embodiment may identify first content according to the first application executed in the foreground of the main display 210 and display the identified first content on the main display 210.

As an embodiment, the electronic device 101 may store data related to the first content to be displayed on the main display 210 in first graphics memory (e.g., the first graphics memory 215 in FIG. 2).

The electronic device 101 according to an embodiment may identify second content to be displayed on the sub-display 220, based on the first application. As an embodiment, the electronic device 101 may identify second content related to the first content identified based on the first application. For example, the electronic device 101 may identify data or details related to the first content as the second content. For example, the electronic device 101 may identify content obtained by expanding the first content (e.g., to the additional space or back side) or changing its display format as the second content. For example, the electronic device 101 may identify a previous screen of the first content as the second content.

The electronic device 101 according to an embodiment may identify second content to be displayed on the sub-display 220, based on a second application that is executed by reflecting an input to the first content. For example, the electronic device 101 may execute a second application, based on a user's input to the first content based on the first application running in the foreground of the main display 210.

As an embodiment, the electronic device 101 may execute a second application in a separate foreground for the sub-display 220. For example, the electronic device 101 may execute a second application, such as an Internet search, a dictionary search, or a newspaper search, based on a user's input to text or images included in the first content.

As an embodiment, the electronic device 101 may identify second content to be displayed on the sub-display 220, based on the executed second application. As an embodiment, the electronic device 101 may store data related to the second content to be displayed on the sub-display 220 in second graphics memory (e.g., the second graphics memory 225 in FIG. 2).

As an embodiment, the electronic device 101 may display the second content on the sub-display 220 in the case where a specified condition is satisfied. As an embodiment, the electronic device 101 may stop displaying the screen of the main display 210 and display the second content only on the sub-display 220 in the case where a specified condition is satisfied.

For example, when displaying a screen on the main display 210, the electronic device 101 may stop displaying the screen on the sub-display 220. For example, when displaying a screen on the sub-display 220, the electronic device may stop displaying the screen on the main display 210. For example, when the electronic device 101 stops displaying the screen on the main display 210 or the sub-display 220, reception of a touch input to the main display 210 or the sub-display 220 may be prevented.

As an embodiment, the specified condition may be related to the screen display direction of the main display 210 or the sub-display 220, based on the folding state or the mounting state of the electronic device 101. For example, in the case where the electronic device 101 identifies that the electronic device 101 has been rotated (e.g., flipped) based on at least one value identified by an inertial sensor (e.g., the inertial sensor 250 in FIG. 2) or where the screen display direction of the sub-display 220 corresponds to the direction in which the screen of the electronic device 101 is to be displayed, the electronic device 101 may display the second content on the sub-display 220.

As an embodiment, the electronic device 101 may determine whether a specified condition is satisfied based on the identified first content or second content. For example, in the case where the first content or the second content corresponds to specified content in relation to the display of the sub-display 220, the electronic device 101 may determine that the specified condition is satisfied.

As an embodiment, in the case where the first content is changed, as illustrated in FIGS. 6A and 6B, the electronic device 101 may change the second content. As an embodiment, the electronic device 101 may terminate the second content when the first content is terminated.

As an embodiment, the electronic device 101 may stop displaying the screen of the sub-display 220 in the case where the satisfaction of a specified condition is released.

As an embodiment, in the case where the second content is identified in response to the first content, the electronic device 101 may display an object 610 (e.g., an icon) related to the second content on the main display 210.

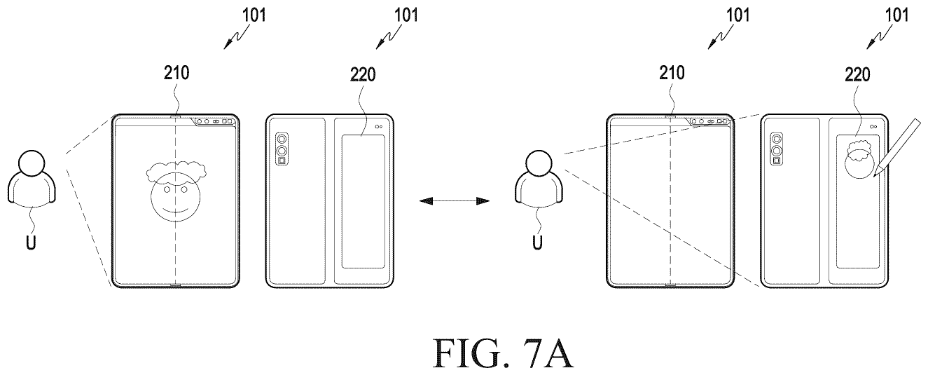

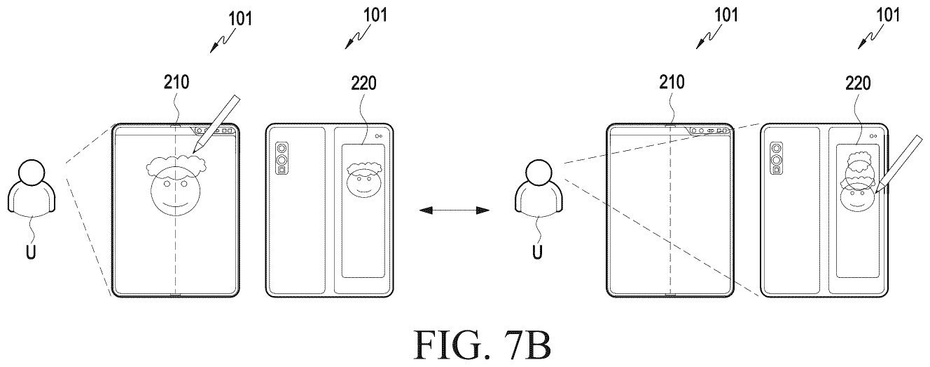

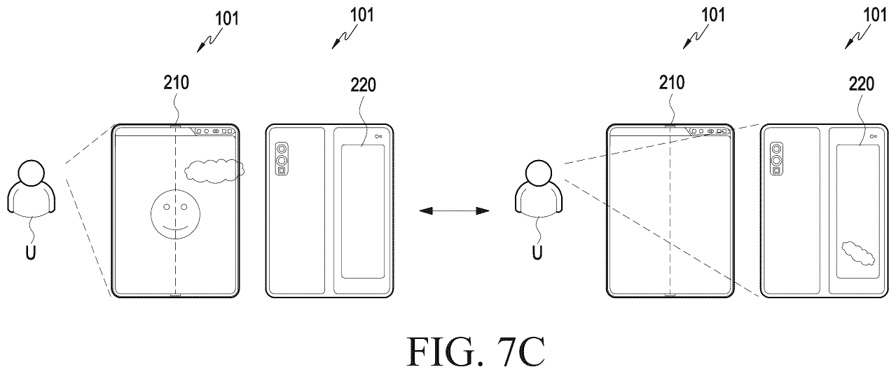

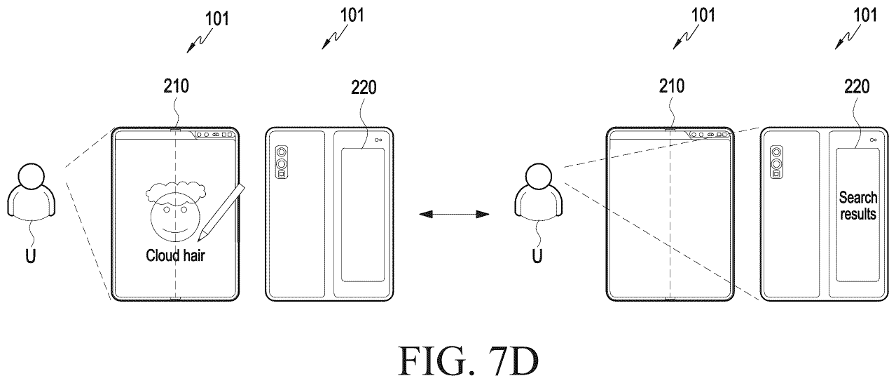

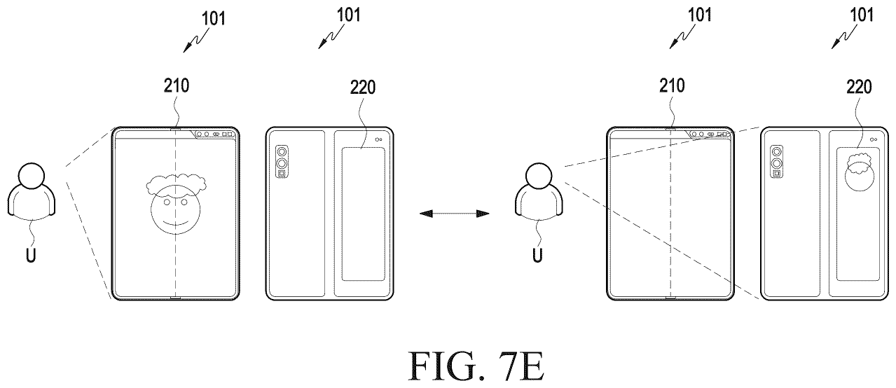

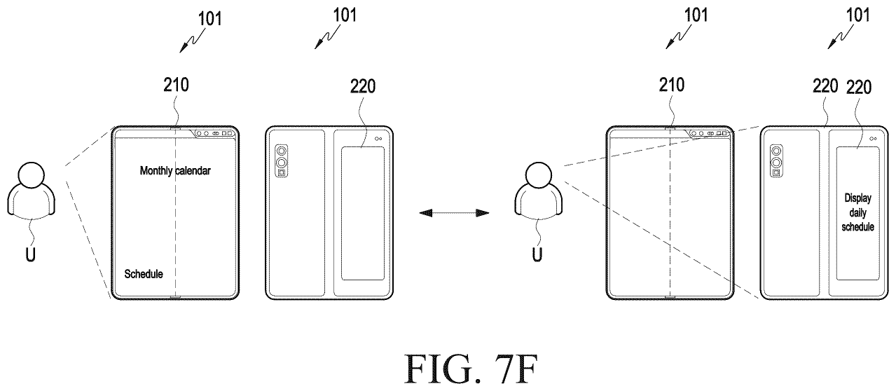

FIGS. 7A, 7B, 7C, 7D, 7E, and 7F illustrate examples of first content and second content of an electronic device 101 according to various embodiments of the disclosure.

Referring to FIGS. 7A, 7B, 7C, 7D, 7E, and 7F, an electronic device 101 according to an embodiment may identify second content, based on a first application that displays first content or based on a second application that is executed by reflecting an input to the first content.

Referring to FIGS. 7A, 7B, and 7C, the electronic device 101 according to an embodiment may identify second content obtained by expanding first content, based on a first application that provides the first content. For example, the first application may be a notepad that allows for writing and editing text or images.

As an embodiment, the electronic device 101, as illustrated in FIG. 7A, may identify second content that expands to the back side of the first content displayed on the main display 210. As an embodiment, the electronic device 101 may provide the second content on the back side of the first content and display it on the sub-display 220.

As an embodiment, the electronic device 101, based on an input of a user U to at least a portion of the first content displayed on the main display 210, as illustrated in FIG. 7B, may move or copy at least a portion of the first content to the second content that expands the back side of the first content, and may display at least a portion of the first content corresponding to the input of the user U on the sub-display 220. For example, the input of the user U may be a long-press input for at least a portion of the first content.

As an embodiment, the electronic device 101 may identify second content that expands a new area of first content displayed on the main display 210, as illustrated in FIG. 7C. As an embodiment, the electronic device 101, based on an input of the user U to at least a portion of the first content, may move or copy at least a portion of the first content to second content that expands a new area of the first content, and may display at least a portion of the first content corresponding to the input of the user U on the sub-display 220. For example, the input of the user U may be a drag input to at least a portion of the first content.

As an embodiment, the electronic device 101, based on a specified input to a resource included in first content, may execute a second application related to the resource, as illustrated in FIG. 7D. As an embodiment, the electronic device may identify second content, based on the executed second application. For example, the resource included in the first content may include text or an image.

For example, the electronic device 101 may acquire a specified input of the user U to a resource included in the first content and execute a search application or search task to search for the resource included in the first content according thereto. For example, the electronic device 101 may identify a search result of the executed search application or search task as the second content.

As an embodiment, the electronic device 101 may identify second content corresponding to a previously displayed screen of first content, based on a first application, as illustrated in FIG. 7E. As an embodiment, when the first content displayed on the main display 210 is changed, the electronic device 101 may identify and store a previously displayed screen of the first content as the second content.

For example, the electronic device 101 may identify and display first content corresponding to an Internet page according to the execution of an Internet application. For example, the electronic device 101 may identify, as the second content, a previous page of the Internet page displayed as the first content. Accordingly, the user U may easily compare options, prices, or specifications of the previous page.

As an embodiment, the electronic device 101 may identify second content obtained by changing the display format of first content, as illustrated in FIG. 7F. As an embodiment, the electronic device 101 may identify second content obtained by changing the display format of at least a portion of the first content, based on an input of the user U to at least the portion of the first content.

For example, the first content may be identified as a monthly calendar according to the execution of an application related to a schedule, and when an input (e.g., touch) of the user U to the schedule included in the first content is received, the electronic device 101 may identify second content corresponding to the daily schedule. For example, when an input of the user U to the schedule in the first content corresponding to the monthly calendar of the calendar application is received, the electronic device 101 may identify the second content corresponding to the detailed schedule. Accordingly, the user U may quickly scan or input information having different display formats by turning the electronic device 101 back and forth and viewing the same.

As an embodiment, in the case where the electronic device 101 identifies first content corresponding to an image or video according to the execution of a gallery application, the electronic device 101 may identify a notepad for making notes on the back side of the image or video as second content.

As an embodiment, in the case where the electronic device 101 identifies first content corresponding to a playlist or the music or video being played according to the execution of a player application for playing music or videos, the electronic device 101 may identify information about the currently playing music and a music list about singers as second content.

As an embodiment, in the case where the electronic device 101 identifies first content regarding health information according to the execution of a health-related application, the electronic device 101 may identify detailed health information as second content. Accordingly, the depth or menu tree of the application may be simplified.

As an embodiment, in the case where the electronic device 101 identifies first content corresponding to an editing screen according to the execution of an editing application for editing videos, music, or images, the electronic device 101 may identify a preview screen of edited data as second content.

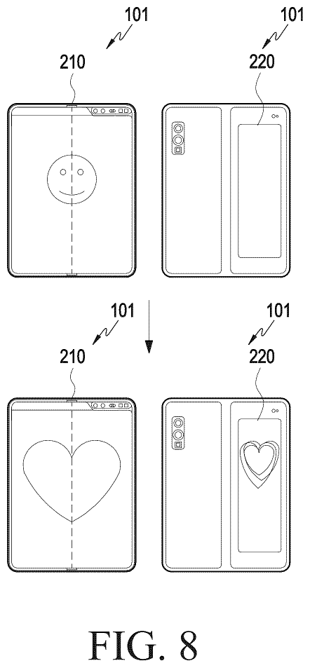

FIG. 8 illustrates changes in first content and second content of an electronic device 101 according to an embodiment of the disclosure.

Referring to FIG. 8, when the first content displayed on the main display 210 is changed, the electronic device 101 according to an embodiment may change the second content to be displayed on the sub-display 220. For example, the electronic device may identify additional information such as a detailed menu or metadata related to the first content as the second content and display it on the sub-display 220. For example, when the details of the first content are changed, the electronic device 101 may identify additional information related to the changed details of the first content as the second content and display it on the sub-display 220.

The electronic device 101 according to an embodiment may identify second content corresponding to first content and, when the first content is changed, identify second content of a different format corresponding to the changed first content. For example, the electronic device 101 may identify and display, as the second content, additional information such as a detailed menu or metadata associated with the first content. For example, when the details of the first content are changed, the electronic device 101 may identify and display second content that displays the changed first content in a different format.

As an embodiment, the electronic device 101 may specify a type of the second content depending on the type of the first content and identify the second content according to the type of the second content specified corresponding to the changed first content.

As an embodiment, the electronic device 101 may terminate the second content when the first content is terminated.

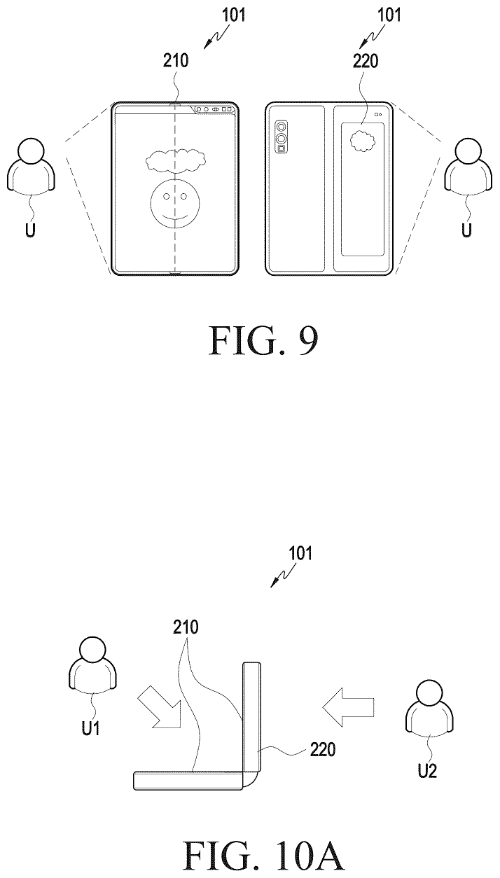

FIG. 9 illustrates a first display 210 and a second display 220 of an electronic device 101 according to an embodiment of the disclosure.

Referring to FIG. 9, an electronic device according to an embodiment may display second content on the sub-display 220 while displaying first content on the main display 210 when a specified condition is satisfied. The electronic device 101 according to an embodiment may operate in a concurrency mode.

As an embodiment, the electronic device 101 may identify satisfaction of a specified condition, based on a request of a first application. For example, if the first application is a specified application or a specified task, the electronic device 101 may determine that the specified condition is satisfied.

As an embodiment, the electronic device 101 may identify satisfaction of a specified condition, based on an application or task related to interactions between a plurality of users. For example, the electronic device 101 may identify satisfaction of a specified condition, based on execution of a presentation application or presentation task. For example, the electronic device 101 may identify satisfaction of a specified condition, based on execution of a fitness application or fitness task.

As an embodiment, the electronic device 101 may execute a second application, based on a request of the first application. As an embodiment, the electronic device 101 may identify satisfaction of a specified condition, based on the execution of the second application.

As an embodiment, the electronic device 101 may identify second content that reflects at least a portion of the first content, based on the second application. For example, the second content may reflect at least a portion of the first content, but may be at least partially different from the first content.

As an embodiment, the electronic device 101 may identify second content corresponding to a size of the sub-display 220, based on the second application.

As an embodiment, the electronic device 101 may receive a user's input corresponding to the first content displayed on the main display 210. As an embodiment, the electronic device 101 may receive a user's input corresponding to the second content displayed on the sub-display. As an embodiment, the electronic device 101 may provide the received user's input to a first application running in the foreground of the main display 210. As an embodiment, the electronic device 101 may provide the received user's input to a second application running in the foreground of the sub-display 220. Accordingly, interactions between a plurality of users may be possible by transmitting user interface information through the main display 210 and the sub-display 220 to each other.

According to an embodiment, the electronic device 101 may operate in a concurrency mode, based on the execution of a first application related to health care or fitness. As an embodiment, the electronic device 101, based on the execution of the first application related to health care or fitness, may identify first content related to exercise motion and display it on the main display 210. As an embodiment, the electronic device 101 may identify an image or video (e.g., mirroring screen) captured using a camera as second content and display it on the sub-display 220.

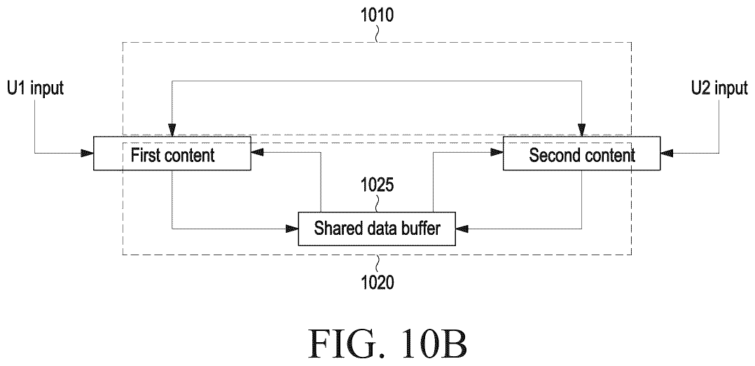

FIG. 10A illustrates a state in which an electronic device 101 operates in a concurrency mode according to an embodiment of the disclosure.

FIG. 10B illustrates signal transmission of an electronic device 101 in a concurrency mode of the electronic device 101 according to an embodiment of the disclosure.

Referring to FIGS. 10A and 10B, an electronic device 101 according to an embodiment may operate in a concurrency mode for displaying respective screens on the main display 210 and the sub-display 220. As an embodiment, a first user U1 may be located to face the main display 210 that displays a screen corresponding to first content. As an embodiment, the electronic device 101 may display a screen corresponding to the first content on the main display 210 to provide the first content to the first user U1 in the concurrency mode. As an embodiment, a second user U2 may be located to face the sub display 220 that displays a screen corresponding to second content. As an embodiment, the electronic device 101 may display a screen corresponding to the second content on the sub display 220 to provide the second content to the second user U2 in the concurrency mode.

The first content according to an embodiment may be identified based on a first application. The second content according to an embodiment may be identified based on the first application in the same manner as the first content.

The second content according to an embodiment may be identified based on a second application corresponding to the first application. For example, the second application may be pre-specified corresponding to the first application in the concurrency mode.

The electronic device 101 according to an embodiment may provide interactions between the first user U1 and the second user U2 through the main display 210 and the sub-display 220. According to an embodiment, the electronic device 101 may transmit, to the second content, interface information according to an input of the first user corresponding to the screen of the first content displayed on the main display 210. As an embodiment, the electronic device 101 may transmit, to the first content, interface information according to an input of the second user U2 corresponding to the screen of the second content displayed on the sub-display 220.

As an embodiment, the electronic device 101 may receive a touch input from the first user U1 through a touch panel provided on the main display 210. As an embodiment, the electronic device 101 may receive a touch input from the first user U1 corresponding to the first content displayed on the main display 210. As an embodiment, the electronic device 101 may receive a touch input from the second user U2 through a touch panel provided on the sub-display 220. As an embodiment, the electronic device 101 may receive a touch input from the second user U2 corresponding to the second content displayed on the sub display 220.

As an embodiment, the electronic device 101 may receive a voice input from the first user U1 located in the screen display direction of the main display 210 through a microphone (e.g., the input module 150 in FIG. 1). As an embodiment, the electronic device 101 may receive a voice input from the second user U2 located in the screen display direction of the sub-display 220 through a microphone (e.g., the input module 150 in FIG. 1). For example, a plurality of microphones may be provided and disposed in the screen display direction of the main display 210 (e.g., front microphones) and the screen display direction of the sub-display 220 (e.g., rear microphones), respectively. For example, the microphone may identify and distinguish between voice inputs from the screen display direction of the main display 210 and the screen display direction of the sub-display 220 through voice beam-forming.

As an embodiment, the electronic device 101 may receive a gesture input from the first user U1 located in the screen display direction of the main display 210 through a camera or a proximity sensor. For example, the electronic device 101 may receive a gesture input from the first user U1 using a front camera. As an embodiment, the electronic device 101 may receive a gesture input from the second user U2 located in the screen display direction of the sub-display 220 through a camera or a proximity sensor. For example, the electronic device 101 may receive a gesture input from the second user U2 using a rear camera.

As an embodiment, the electronic device 101 may use a direct connection method 1010 for directly connecting the first content and the second content. As an embodiment, the electronic device 101 may directly transmit, to the second content, an input corresponding to the first content through the main display 210. As an embodiment, the electronic device 101 may directly transmit, to the first content, an input corresponding to the second content through the sub-display 220. Accordingly, the electronic device 101 may secure fast one-to-one response.

For example, the direct connection method 1010 may be used for transmitting streaming data, playback videos, continuous touch movement events, voice input data, and gesture input data.

The electronic device 101 according to an embodiment may use an indirect connection method 1020 for connecting the first content and the second content through a shared data buffer 1025 (e.g., the memory 130 in FIG. 1). As an embodiment, the electronic device 101 may observe the shared data buffer 1025 in real time and obtain data corresponding to the first content and/or the second content. As an embodiment, the electronic device 101 may update the first content and/or the second content, based on the data acquired corresponding to the first content and/or the second content. For example, the content to be displayed in the data may include a command corresponding to the first content or the second content, or content data to be displayed.

As an embodiment, when using the indirect connection method 1020, a plurality of sub-displays 220 or multiple pieces of second content may be connected to the electronic device 101.

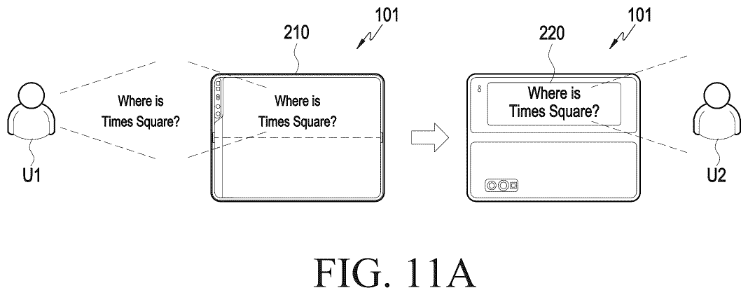

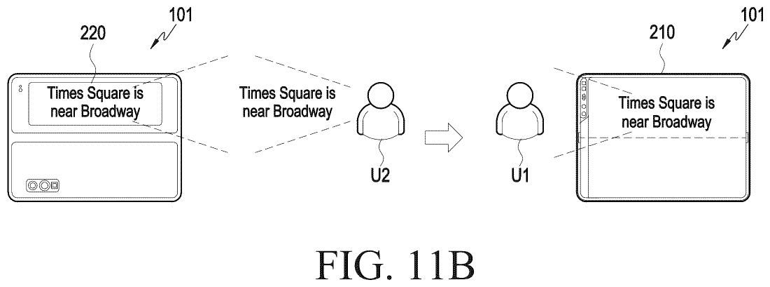

FIGS. 11A and 11B illustrate a first example of an electronic device 101 operating in a concurrency mode according to various embodiments of the disclosure.

Referring to FIGS. 11A and 11B, the electronic device 101 according to an embodiment may identify second content that is at least partially different from first content. As an embodiment, the second content may reflect at least a portion of the first content.

As an embodiment, the first content may be content based on a first application related to speech recognition, and the second content may be content based on a second application related to simultaneous interpretation.

The electronic device 101 according to an embodiment, based on the first application running in the foreground of the main display 210, may receive text input or voice input from the first user U1. For example, the electronic device 101 may recognize a voice input through NPU-based speech recognition and identify first content corresponding to the recognized text through speech-to-text (STT), thereby displaying it on the main display 210.

The electronic device 101 according to an embodiment may receive text corresponding to a voice input from the first content, based on the second application running in the foreground of the sub-display 220, and identify second content corresponding to text that is an interpretation or translation of the received text into a specified foreign language (e.g., English). For example, the electronic device 101 may interpret or translate the text corresponding to the voice input in real time, based on artificial intelligence (AI) on the electronic device 101. For example, the electronic device 101 may display the second content on the screen of the sub-display 220 or provide a sound corresponding to the interpreted or translated text to a speaker (e.g., the sound output module 155 in FIG. 1).

The electronic device 101 according to an embodiment may receive a voice input corresponding to a specified foreign language from the second user U2, based on a second application running in the foreground of the sub-display 220, identify text corresponding to the received voice input as the second content, and display it on the sub-display 220.

The electronic device 101 according to an embodiment may receive text corresponding to a voice input from the second content, based on a first application running in the foreground of the main display 210, and identify first content corresponding to the text obtained by interpreting or translating the received text into a specified language (e.g., Korean). For example, the electronic device 101 may display the first content on the screen of the main display 210 or provide a sound corresponding to the interpreted or translated text to the speaker.

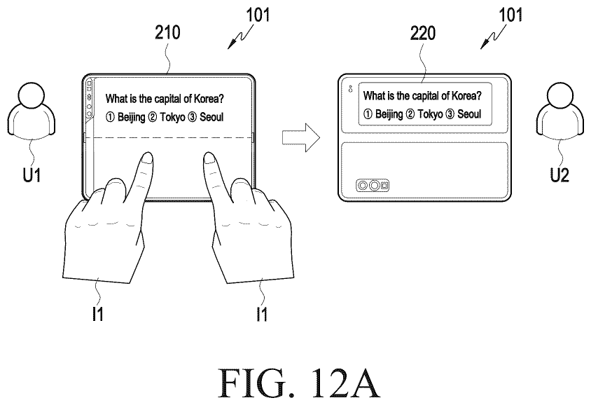

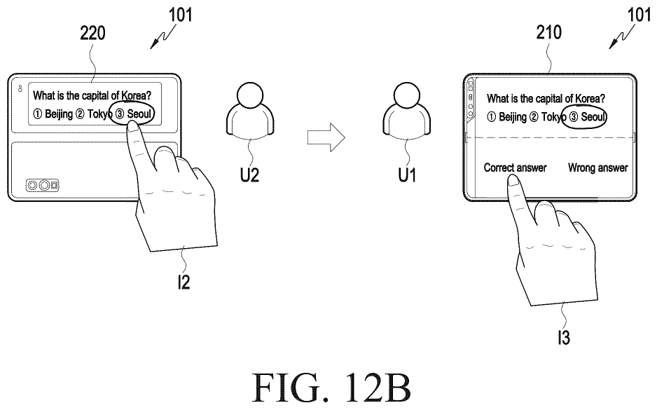

FIGS. 12A and 12B illustrate a second example of an electronic device 101 operating in a concurrency mode according to various embodiments of the disclosure.

Referring to FIGS. 12A and 12B, the electronic device 101 according to an embodiment may identify second content that is at least partially different from first content. As an embodiment, the second content may reflect at least a portion of the first content.

As an embodiment, the first content may be content based on a first application related to tutoring. As an embodiment, the second content may be content based on the first application, or content based on a second application that is executed separately in response to the first application.

The electronic device 101 according to an embodiment may identify first content corresponding to an input 11 of the first user U1 that is input by selection or direct typing, based on a first application related to a quiz, and display the identified first content on the main display 210. As an embodiment, the electronic device 101 may transmit, to a second application, data corresponding to the first content corresponding to the input 11 of the first user and display second content related to the quiz identified based on the second application on the sub-display 220.

The electronic device 101 according to an embodiment may receive an event input 12 (e.g., a touch input) from the second user U2 in response to the second content displayed on the screen of the sub-display 220. As an embodiment, the electronic device 101 may transmit, to the first application, data corresponding to an event input 12 received in response to the second content. For example, the electronic device 101 may receive an event input 12 corresponding to at least a portion (e.g., answer choices) of the second content related to a quiz from the second user U2 and transmit data corresponding to the received event input 12 to the first application.

The electronic device 101 according to an embodiment may update the first content displayed on the main display 210 in response to the event input 12 corresponding to at least a portion of the second content, which was transmitted to the first application. For example, the electronic device 101 may reflect at least a portion (e.g., answer choices) of the second content corresponding to the event input 12 to the first content displayed on the screen of the main display 210. Additionally, the electronic device 101, based on the reception of the event input 12, may provide the first content with an option related to a selection that provides feedback (e.g., correct or incorrect answers) in response to the event input 12. For example, in response to an input 13 of the first user to the option related to a selection that provides feedback (e.g., correct or incorrect answers) in response to the event input 12, the electronic device 101 may transmit data related to the feedback to the second content.

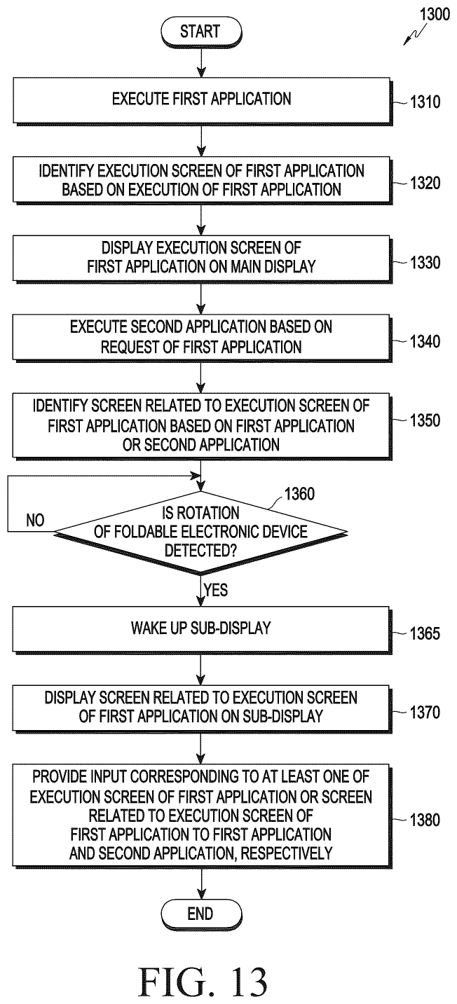

FIG. 13 is a flowchart 1300 of a method of operating an electronic device 101 according to an embodiment of the disclosure.

The operations described in FIG. 13 may be performed by the electronic device 101. The memory of the electronic device 101 may store instructions that the electronic device to perform the following operations.

Referring to FIG. 13, an electronic device 101 according to an embodiment may execute a first application in operation 1310. For example, the electronic device 101 may execute the first application in response to a user's input, or may automatically execute the first application, based on the satisfaction of a specific condition.

The electronic device 101 according to an embodiment, based on the executed first application, may identify first content to be displayed on the screen in operation 1320. As an embodiment, the electronic device 101 may identify first content to be displayed on the main display 210 in response to the executed first application. For example, the first application may be executed in the foreground of the main display 210.

The electronic device 101 according to an embodiment may display the identified first content on the main display 210 in operation 1330. For example, the first content may be updated in real time, based on the first application.

The electronic device 101 according to an embodiment may execute a second application, based on a request of the first application, in operation 1340. As an embodiment, the electronic device 101 may execute the second application in the foreground of the sub-display 220.

For example, the electronic device 101, based on the execution of the first application, may automatically execute the second application specified to correspond to the first application. For example, when the electronic device 101 receives a user's input in response to the first application, the electronic device 101 may execute the second application.

As an embodiment, the electronic device 101 may omit operation 1340 and identify the second content, based on the first application. As an embodiment, the electronic device 101 may omit operation 1340 of executing the second application in the case where the second content is identified based on the first application.

The electronic device 101 according to an embodiment, based on the first application or based on the second application, may identify second content, which is at least partially different from the first content, in operation 1350.

As an embodiment, the electronic device 101 may identify the second content, based on the first application that identified the first content.

As an embodiment, the electronic device 101 may identify the second content, based on the executed second application.

As an embodiment, the electronic device 101 may update the second content in real time, based on the first application or based on the second application. As an embodiment, the second content may be updated to change or terminate depending on the update of the first content.

As an embodiment, the electronic device 101 may store the identified second content in the memory.

As an embodiment, the electronic device 101 may determine whether rotation of the electronic device 101 is detected in operation 1360. For example, the electronic device 101 may detect rotation of the electronic device 101, based on at least one measurement value acquired from at least one sensor 250, 260, or 270.

As an embodiment, in the case where the rotation of the electronic device 101 is detected (Yes in operation 1360), the electronic device 101 may wake up the sub-display 220. For example, the electronic device 101 may wake up the sub-display 220, which is in a sleep state and does not display a screen, to display a screen.

The electronic device 101 according to an embodiment may display the second content on the awakened sub-display 220 in operation 1370.

The electronic device 101 according to an embodiment, in the case where the rotation of the electronic device 101 is not detected (No in operation 1360), may not display the second content on the sub-display 220 and may not wake up the sub-display 220.

The electronic device 101 according to an embodiment may provide an input corresponding to at least one piece of the first content or the second content to the first application and the second application, respectively, in operation 1380.

As an embodiment, the electronic device 101 may receive an input corresponding to the first content through the main display 210 and transmit the received input to the first application while also transmitting it to the second application. Accordingly, the input corresponding to the first content may be reflected in both the first content and the second content.

As an embodiment, the electronic device 101 may receive an input corresponding to the second content through the sub-display 220 and transmit the received input to the second application while also transmitting it to the first application. Accordingly, the input corresponding to the second content may be reflected in both the first content and the second content.

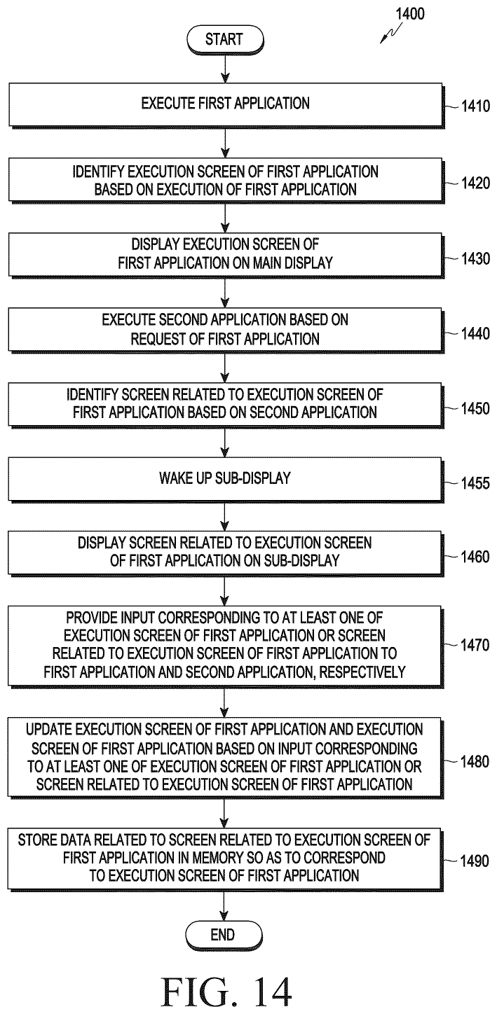

FIG. 14 is a flowchart 1400 of a method of operating an electronic device 101 according to an embodiment of the disclosure.

The operations described in FIG. 14 may be performed by the electronic device 101. The memory of the electronic device 101 may store instructions that the electronic device to perform the following operations.

Referring to FIG. 14, an electronic device 101 according to an embodiment may execute a first application in operation 1410. For example, the electronic device 101 may execute the first application in response to a user's input, or may automatically execute the first application, based on the satisfaction of a specific condition.

As an embodiment, the electronic device 101 may execute the first application in the foreground of the main display 210.

The electronic device 101 according to an embodiment may identify first content to be displayed on a screen, based on the executed first application, in operation 1420. As an embodiment, the electronic device 101 may identify first content to be displayed on the main display 210 in response to the executed first application.

The electronic device 101 according to an embodiment may display the identified first content on the main display 210 in operation 1430.

The electronic device 101 according to an embodiment may execute a second application, based on a request of the first application, in operation 1440. As an embodiment, the electronic device 101 may execute the second application in the foreground of the sub-display 220.

For example, the second application may be specified to correspond to the first application executed in the foreground of the main display 210, or may be executed based on a user's input corresponding to the first content.

The electronic device 101 according to an embodiment may identify second content, based on the second application, in operation 1450. As an embodiment, the electronic device 101 may identify the second content to be displayed on the screen of the sub-display 220, based on the second application executed in the foreground of the sub-display 220.

The electronic device 101 according to an embodiment may wake up the sub-display 220 in operation 1455. As an embodiment, the electronic device 101 may wake up the sub-display 220, which is in a sleep state where a screen is not displayed, in the case where the second application is executed according to a request of the first application or where a screen related to the execution screen of the first application to be displayed on the sub-display 220 is identified based on the second application.

The electronic device 101 according to an embodiment may display the second content on the sub-display 220 in operation 1460. As an embodiment, the electronic device 101 may display the first content on the main display 210 and simultaneously display the second content on the sub-display 220.

The electronic device 101 according to an embodiment may provide an input corresponding to at least one piece of the first content or the second content to the first application and the second application, respectively, in operation 1470.

The electronic device 101 according to an embodiment may update the first content and the second content, respectively, based on the input corresponding to at least one piece of the first content or the second content, in operation 1480.

As an embodiment, the electronic device 101 may receive an input corresponding to the first content through the main display 210, and may transmit the received input to the first application while also transmitting it to the second application. Accordingly, the input corresponding to the first content may be reflected in both the first content and the second content.

As an embodiment, the electronic device 101 may receive an input corresponding to the second content through the sub-display 220, and may transmit the received input to the second application while also transmitting it to the first application. Accordingly, the input corresponding to the second content may be reflected in both the first content and the second content.

Accordingly, the electronic device 101 may implement interactions between the first user and the second user by updating the first content and the second content, respectively, based on the input of the first user or the second user corresponding to the first content or the second content.

The electronic device 101 according to an embodiment may store data related to the second content in the memory so as to correspond to the first content in operation 1490.

As an embodiment, when the electronic device 101 identifies the first content to be displayed on the main display 210, it may identify the second content to be displayed on the sub-display 220, based on data related to the second content corresponding to the first content, which is stored in the memory.

The technical problems to be solved in this document are not limited to the technical problems mentioned above, and other technical problems not mentioned will be clearly understood by those skilled in the art to which this document pertains from the description below.

The effects obtainable from the disclosure are not limited to the effects mentioned above, and other effects not mentioned will be clearly understood by those skilled in the art to which the disclosure pertains from the description below.

A foldable electronic device 101 according to an embodiment of the disclosure may include a first housing 410, a second housing 420 rotatably coupled to the first housing 410, a main display 210 including a first display region of the first housing 410 and a second display region of the second housing 420, a sub-display 220 including a third display region of the first housing 410, the third display region being configured to display a screen in a different direction from the first display region, at least one sensor 250, 260, or 270 configured to acquire at least one measurement value related to rotation of the foldable electronic device 101, memory 240 or 130 configured to store instructions, and at least one processor 230 or 120. The instructions may cause, when executed by the at least one processor 230 or 120, the foldable electronic device 101 to display an execution screen of a first application on the main display 210, based on execution of the first application. The instructions may cause, when executed by the at least one processor 230 or 120, the foldable electronic device 101 to detect rotation of the foldable electronic device 101, based on the at least one measurement value acquired from the at least one sensor 250, 260, or 270. The instructions may cause, when executed by the at least one processor 230 or 120, the foldable electronic device 101 to wake up the sub-display 220, based on the detection of the rotation of the foldable electronic device 101. The instructions may cause, when executed by the at least one processor 230 or 120, the foldable electronic device 101 to display a screen related to the execution screen of the first application on the sub-display 220.

In the foldable electronic device 101 according to an embodiment, the instructions may cause, when executed by the at least one processor 230 or 120, the foldable electronic device 101 to detect, at least as a part of the operation of detecting the rotation of the foldable electronic device 101, whether a direction in which a screen of the foldable electronic device 101 is to be displayed has changed, based on the at least one measurement value.

In the foldable electronic device 101 according to an embodiment, the at least one sensor 250, 260, or 270 may include a first inertial sensor 253 configured to acquire at least one first value related to rotation of the first housing 410, and a second inertial sensor 255 configured to acquire at least one second value related to rotation of the second housing 420. The instructions may cause, when executed by the at least one processor 230 or 120, the foldable electronic device 101 to detect, at least as a part of the operation of detecting the rotation of the foldable electronic device 101, the rotation of the foldable electronic device 101, based on at least one of the first value or the second value.

In the foldable electronic device 101 according to an embodiment, the instructions may cause, when executed by the at least one processor 230 or 120, the foldable electronic device 101 to identify, as at least a part of the operation of detecting the rotation of the foldable electronic device 101, a screen display direction of the main display 210 or the sub-display 220, based on at least one of the first value or the second value, and detect the rotation of the foldable electronic device 101, based on whether the screen display direction of the main display 210 or the sub-display 220 corresponds to a direction exposed to a user.

In the foldable electronic device 101 according to an embodiment, the instructions may cause, when executed by the at least one processor 230 or 120, the foldable electronic device 101 to identify a screen related to the execution screen of the first application as a screen that expands the execution screen of the first application, changes a display format of the execution screen of the first application, or adds data related to the execution screen of the first application.

In the foldable electronic device 101 according to an embodiment, the instructions may cause, when executed by the at least one processor 230 or 120, the foldable electronic device 101 to identify a screen related to the execution screen of the first application as a screen previously displayed before the execution screen of the first application displayed on the main display 210.

In the foldable electronic device 101 according to an embodiment, the instructions may cause, when executed by the at least one processor 230 or 120, the foldable electronic device 101 to execute a second application, based on a specified input to a resource included in the execution screen of the first application. The instructions may cause, when executed by the at least one processor 230 or 120, the foldable electronic device 101 to identify a screen related to the execution screen of the first application, based on the second application.

In the foldable electronic device 101 according to an embodiment, the instructions may cause, when executed by the at least one processor 230 or 120, the foldable electronic device 101 to execute the second application, based on a request of the first application. The instructions may cause the foldable electronic device to identify a screen related to the execution screen of the first application, which reflects at least a portion of the execution screen of the first application, based on the second application.

In the foldable electronic device 101 according to an embodiment, the first application may be executed in a foreground of the main display 210. In the electronic device according to an embodiment, the second application may be executed in a foreground of the sub-display 220. In the electronic device according to an embodiment, the instructions may cause, when executed by the at least one processor 230 or 120, the foldable electronic device 101 to provide an input corresponding to at least one of the execution screen of the first application or a screen related to the execution screen of the first application to the first application and the second application, respectively.

In the foldable electronic device 101 according to an embodiment, the instructions may cause, when executed by the at least one processor 230 or 120, the foldable electronic device 101 to change or terminate a screen related to the execution screen of the first application, based on change or termination of the execution screen of the first application.

The foldable electronic device 101 according to an embodiment may further include first graphics memory 215 configured to store data related to the execution screen of the first application to be displayed on the main display 210, and second graphics memory 225 configured to store data related to a screen related to the execution screen of the first application to be displayed on the sub-display 220.

An operation method of a foldable electronic device 101 according to an embodiment of the disclosure may include an operation 1330 or 1430 of displaying an execution screen of a first application on a main display 210, based on execution of the first application. The main display 210 may include a first display region of a first housing 410 and a second display region of a second housing 420 rotatably coupled to the first housing 410. The operation method of a foldable electronic device 101 according to an embodiment may include an operation 1360 of detecting rotation of the foldable electronic device 101, based on at least one measurement value acquired from at least one sensor 250, 260, or 270 and related to the rotation of the foldable electronic device 101. The operation method of a foldable electronic device 101 according to an embodiment may include an operation 1365 of waking up a sub-display 220, based on the detection of the rotation of the foldable electronic device 101. The sub-display 220 may include a third display region of the first housing 410 configured to display a screen in a different direction from the first display region. The operation method of a foldable electronic device 101 according to an embodiment may include an operation 1370 or 1460 of displaying a screen related to the execution screen of the first application on the sub-display 220.

In the operation method of a foldable electronic device 101 according to an embodiment, the operation 1360 of detecting the rotation of the foldable electronic device 101 may include detecting the rotation of the foldable electronic device 101, based on at least one of at least one first value acquired from a first inertial sensor 253 and related to rotation of the first housing 410 or at least one second value acquired from a second inertial sensor 255 and related to rotation of the second housing 420.

The operation method of a foldable electronic device 101 according to an embodiment may include an operation 1340 or 1440 of executing the second application, based on a request of the first application. The operation method of a foldable electronic device 101 according to an embodiment may further include an operation 1350 or 1450 of identifying a screen related to the execution screen of the first application, which reflects at least a portion of the execution screen of the first application, based on the second application.

In the operation method of a foldable electronic device 101 according to an embodiment, the first application may be executed in a foreground of the main display 210, and the second application may be executed in a foreground of the sub-display 220.

The operation method of a foldable electronic device 101 according to an embodiment may include an operation 1380 or 1470 of providing an input corresponding to at least one of the execution screen of the first application or a screen related to the execution screen of the first application to the first application and the second application, respectively.

A computer-readable storage medium according to an embodiment of the disclosure may store instructions, wherein the instructions may cause, when executed by at least one processor 230 or 120 of a foldable electronic device 101, the foldable electronic device 101 to display an execution screen of a first application on a main display 210, based on execution of the first application. The main display 210 may include a first display region of a first housing 410 and a second display region of a second housing 420 rotatably coupled to the first housing. The instructions may cause, when executed by the at least one processor 230 or 120, the foldable electronic device 101 to detect rotation of the foldable electronic device 101, based on at least one measurement value acquired from at least one sensor 250, 260, or 270 and related to the rotation of the foldable electronic device 101. The instructions may cause, when executed by the at least one processor 230 or 120, the foldable electronic device 101 to wake up a sub-display 220, based on the detection of the rotation of the foldable electronic device 101. The sub-display 220 may include a third display region of the first housing 410 configured to display a screen in a different direction from the first display region. The instructions may cause, when executed by the at least one processor 230 or 120, the foldable electronic device 101 to display a screen related to the execution screen of the first application on the sub-display 220. A foldable electronic device 101 according to an embodiment of the disclosure may include a first housing 410, a second housing 420 rotatably coupled to the first housing 410, a main display 210 including a first display region of the first housing 410 and a second display region of the second housing 420, a sub-display 220 including a third display region of the first housing 410, the third display region being configured to display a screen in a different direction from the first display region, memory 240 or 130 configured to store executable instructions, and at least one processor 230 or 120 configured to access the memory 240 or 130 and execute the instructions. The instructions may cause, when executed by the at least one processor 230 or 120, the foldable electronic device 101 to display an execution screen of a first application on the main display 210, based on execution of the first application. The instructions may cause, when executed by the at least one processor 230 or 120, the foldable electronic device 101 to execute a second application, based on a request of the first application. The instructions may cause, when executed by the at least one processor 230 or 120, the foldable electronic device 101 to display, based on the second application, a screen related to the execution screen of the first application, which reflects at least a portion of a screen related to the execution screen of the first application, on the sub-display 220. The instructions may cause, when executed by the at least one processor 230 or 120, the foldable electronic device 101 to provide an input corresponding to at least one of the execution screen of the first application or a screen related to the execution screen of the first application to the first application and the second application, respectively.

The foldable electronic device 101 according to an embodiment of the disclosure may further include first graphics memory 215 configured to store data related to the execution screen of the first application to be displayed on the main display 210, and second graphics memory 225 configured to store data related to a screen related to the execution screen of the first application to be displayed on the sub-display 220.

In the foldable electronic device 101 according to an embodiment of the disclosure, the first application may be executed in a foreground of the main display 210, and the second application may be executed in a foreground of the sub-display 220.

In the foldable electronic device 101 according to an embodiment of the disclosure, the instructions may cause, when executed by the at least one processor 230 or 120, the foldable electronic device 101 to update the execution screen of the first application and the screen related to the execution screen of the first application, respectively, based on an input corresponding to at least one of the execution screen of the first application or the screen related to the execution screen of the first application.

In the foldable electronic device 101 according to an embodiment of the disclosure, the instructions may cause, when executed by the at least one processor 230 or 120, the foldable electronic device 101 to store data related to a screen related to the identified execution screen of the first application in the memory 240 or 130 so as to correspond to the execution screen of the first application, and identify the screen related to the execution screen of the first application, based on the stored data related to the screen related to the execution screen of the first application.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added.

Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A foldable electronic device comprising:
a first housing;
a second housing rotatably coupled to the first housing;
a main display comprising a first display region provided on the first housing and a second display region provided on the second housing;
a sub-display comprising a third display region of the first housing, the third display region being configured to display a screen in a different direction from the first display region;
at least one sensor configured to acquire at least one measurement value related to rotation of the foldable electronic device;
memory, comprising one or more storage media, storing instructions; and
at least one processor including processing circuitry, the at least one processor communicatively coupled to the memory,
wherein the instructions, when executed by the at least one processor individually or collectively, cause the foldable electronic device to:
display an execution screen of a first application on the main display, based on execution of the first application,
detect rotation of the foldable electronic device, based on the at least one measurement value acquired from the at least one sensor,
wake up the sub-display, based on the detection of the rotation of the foldable electronic device, and
display a screen related to the execution screen of the first application on the sub-display.

2. The foldable electronic device of claim 1, wherein the instructions, when executed by the at least one processor individually or collectively, further cause the foldable electronic device to:
detect, as at least part of detecting the rotation of the foldable electronic device, whether a direction in which a screen of the foldable electronic device is displayed has changed, based on the at least one measurement value.

3. The foldable electronic device of claim 1,
wherein the at least one sensor comprises:
a first inertial sensor configured to acquire at least one first value related to rotation of the first housing, and
a second inertial sensor configured to acquire at least one second value related to rotation of the second housing, and
wherein the instructions, when executed by the at least one processor individually or collectively, further cause the foldable electronic device to detect, as at least part of detecting the rotation of the foldable electronic device, the rotation of the foldable electronic device, based on at least one of the first value or the second value.

4. The foldable electronic device of claim 3, wherein the instructions, when executed by the at least one processor individually or collectively, further cause, as at least part of detecting the rotation of the foldable electronic device, the foldable electronic device to:
identify a screen display direction of the main display or the sub-display, based on at least one of the first value or the second value; and
detect the rotation of the foldable electronic device, based on whether the screen display direction of the main display or the sub-display corresponds to a direction of the foldable electronic device facing a user.

5. The foldable electronic device of claim 1, wherein the instructions, when executed by the at least one processor individually or collectively, further cause the foldable electronic device to:
identify a screen related to the execution screen of the first application as a screen that expands the execution screen of the first application, a screen that changes a display format of the execution screen of the first application, or a screen that adds data related to the execution screen of the first application.

6. The foldable electronic device of claim 1, wherein the instructions, when executed by the at least one processor individually or collectively, further cause the foldable electronic device to:
identify a screen related to the execution screen of the first application as a screen displayed before the execution screen of the first application displayed on the main display.

7. The foldable electronic device of claim 1, wherein the instructions, when executed by the at least one processor individually or collectively, further cause the foldable electronic device to:
execute a second application, based on a specified input to a resource included in the execution screen of the first application; and
identify a screen related to the execution screen of the first application, based on the second application.

8. The foldable electronic device of claim 7, wherein the instructions, when executed by the at least one processor individually or collectively, further cause the foldable electronic device to:
execute the second application, based on a request of the first application; and
identify a screen related to the execution screen of the first application, which reflects at least a portion of the execution screen of the first application, based on the second application.

9. The foldable electronic device of claim 8,
wherein the first application is executed in a foreground of the main display,
wherein the second application is executed in a foreground of the sub-display, and
wherein the instructions, when executed by the at least one processor individually or collectively, further cause the foldable electronic device to:
provide an input corresponding to at least one of the execution screen of the first application or a screen related to the execution screen of the first application to the first application and the second application, respectively.

10. The foldable electronic device of claim 1, wherein the instructions, when executed by the at least one processor individually or collectively, further cause the foldable electronic device to:
change or terminate a screen related to the execution screen of the first application, based on change or termination of the execution screen of the first application.

11. The foldable electronic device of claim 1, further comprising:
first graphics memory configured to store data related to the execution screen of the first application to be displayed on the main display; and
second graphics memory configured to store data related to a screen related to the execution screen of the first application to be displayed on the sub-display.

12. An operation method performed by a foldable electronic device, the operation method comprising:
displaying an execution screen of a first application on a main display, based on execution of the first application, the main display comprising a first display region of a first housing and a second display region of a second housing rotatably coupled to the first housing;
detecting rotation of the foldable electronic device, based on at least one measurement value acquired from at least one sensor and related to the rotation of the foldable electronic device;
waking up a sub-display, based on the detection of the rotation of the foldable electronic device, the sub-display comprising a third display region of the first housing configured to display a screen in a different direction from the first display region; and
an operation of displaying a screen related to the execution screen of the first application on the sub-display.

13. The operation method of claim 12, wherein detecting the rotation of the foldable electronic device comprises:
detecting the rotation of the foldable electronic device, based on at least one of at least one first value acquired from a first inertial sensor and related to rotation of the first housing or at least one second value acquired from a second inertial sensor and related to rotation of the second housing.

14. The operation method of claim 12, further comprising:
executing a second application, based on a request of the first application; and
identifying a screen related to the execution screen of the first application, which reflects at least a portion of the execution screen of the first application, based on the second application.

15. A foldable electronic device comprising:
a first housing;
a second housing rotatably coupled to the first housing;
a main display comprising a first display region provided on the first housing and a second display region provided on the second housing;
a sub-display comprising a third display region of the first housing, the third display region being configured to display a screen in a different direction from the first display region;
memory, comprising one or more storage media, storing instructions; and
at least one processor including processing circuitry, the at least one processor communicatively coupled to the memory,
wherein the instructions, when executed by the at least one processor individually or collectively, cause the foldable electronic device to:
display an execution screen of a first application on the main display, based on execution of the first application,
execute a second application, based on a request of the first application,
display, based on the second application, a screen related to the execution screen of the first application, which reflects at least a portion of the execution screen of the first application, on the sub-display, and
provide an input corresponding to at least one of the execution screen of the first application or a screen related to the execution screen of the first application to the first application and the second application, respectively.

16. The foldable electronic device of claim 15, wherein the instructions, when executed by the at least one processor individually or collectively, further cause the foldable electronic device to:
identify a screen related to the execution screen of the first application as a screen that expands the execution screen of the first application, a screen that changes a display format of the execution screen of the first application, or a screen that adds data related to the execution screen of the first application.

17. The foldable electronic device of claim 15, wherein the instructions, when executed by the at least one processor individually or collectively, further cause the foldable electronic device to:
identify a screen related to the execution screen of the first application as a screen displayed before the execution screen of the first application displayed on the main display.

18. The foldable electronic device of claim 15, wherein the instructions, when executed by the at least one processor individually or collectively, further cause the foldable electronic device to:
execute a second application, based on a specified input to a resource included in the execution screen of the first application; and
identify a screen related to the execution screen of the first application, based on the second application.

19. The foldable electronic device of claim 18, wherein the instructions, when executed by the at least one processor individually or collectively, further cause the foldable electronic device to:
execute the second application, based on a request of the first application; and
identify a screen related to the execution screen of the first application, which reflects at least a portion of the execution screen of the first application, based on the second application.

20. The foldable electronic device of claim 19,
wherein the first application is executed in a foreground of the main display,
wherein the second application is executed in a foreground of the sub-display, and
wherein the instructions, when executed by the at least one processor individually or collectively, further cause the foldable electronic device to:
provide an input corresponding to at least one of the execution screen of the first application or a screen related to the execution screen of the first application to the first application and the second application, respectively.
